(19) United States
(12) Patent Application Publication
(10) Pub. No.: US 2013/0246977 A1
(43) Pub. Date: Sep. 19, 2013

(54) MULTI-CONTEXT DATA BINDING

(71) Applicants: Jeremy J. Jensen, Moorhead, MN (US); Ashley P. Polkinghorn, West Fargo, ND (US); Adrian L. Orth, West Fargo, ND (US)

(72) Inventors: Jeremy J. Jensen, Moorhead, MN (US); Ashley P. Polkinghorn, West Fargo, ND (US); Adrian L. Orth, West Fargo, ND (US)

(73) Assignee: Microsoft Corporation, Redmond, WA (US)

(21) Appl. No.: 13/421,879

(22) Filed: Mar. 16, 2012

(51) Int. Cl. G06F 3/048

(52) U.S. Cl. 715/854

(57) ABSTRACT

A data binding is defined by a binding path that can point to any given location in a hierarchical data structure. The binding can bind to an object that has a collection of properties. The binding itself defines its own context and can be implemented as two-way binding so that data changes can be tracked.

### BACKGROUND

Data binding is a term commonly used to describe how a connection is established between an application user interface control and data as well as business logic. If the data is properly bound to the user interface elements, and if the data provides proper notifications when it is changed, then elements bound to data reflect changes automatically. By way of one specific example, an application may generate a user interface display that has forms or other user interface control elements on it. User data, or local configuration data, can be bound to user interface displays to place data within the forms or within the other user interface controls, or to define behavior of the controls.

In addition, in enterprise resource planning or customer resource management (ERP/CRM) applications, there are often many different types of data records. For instance, there may be customer data records, each of which have one or more sales orders, where each sales order is a collection of lines and each line is a collection of properties. This type of arrangement is referred to as a hierarchical data structure. It is basically a large hierarchical tree of nodes that define an object graph. When a particular data record is retrieved and displayed on a user interface display, the display attempts to show the large, complex object graph on the screen. This can be difficult and cumbersome.

The discussion above is merely provided for general background information and is not intended to be used as an aid in determining the scope of the claimed subject matter.

### SUMMARY

A data binding is defined by a binding path that can point to any given location in a hierarchical data structure. The binding can bind to an object that has a collection of properties. The binding itself defines its own context and can be implemented as two-way binding so that data changes can be tracked.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a system that uses data bindings.

FIG. 2 is a diagram of a binding framework.

FIG. 3 is a sequence diagram illustrating one embodiment of the operation of the framework shown in FIG. 2 for generating two-way data bindings.

FIG. 4 is a sequence diagram illustrating how physical and logical elements interact with the data element.

FIG. 5 is one example of a specific data model.

FIG. 6 is one example of a user interface display generated from the data model shown in FIG. 5.

FIGS. 7 and 8 illustrate one embodiment of an application in different cloud computing architectures.

FIGS. 9-11 illustrate mobile devices.

FIG. 12 shows a block diagram of one illustrative computing environment.

### DETAILED DESCRIPTION

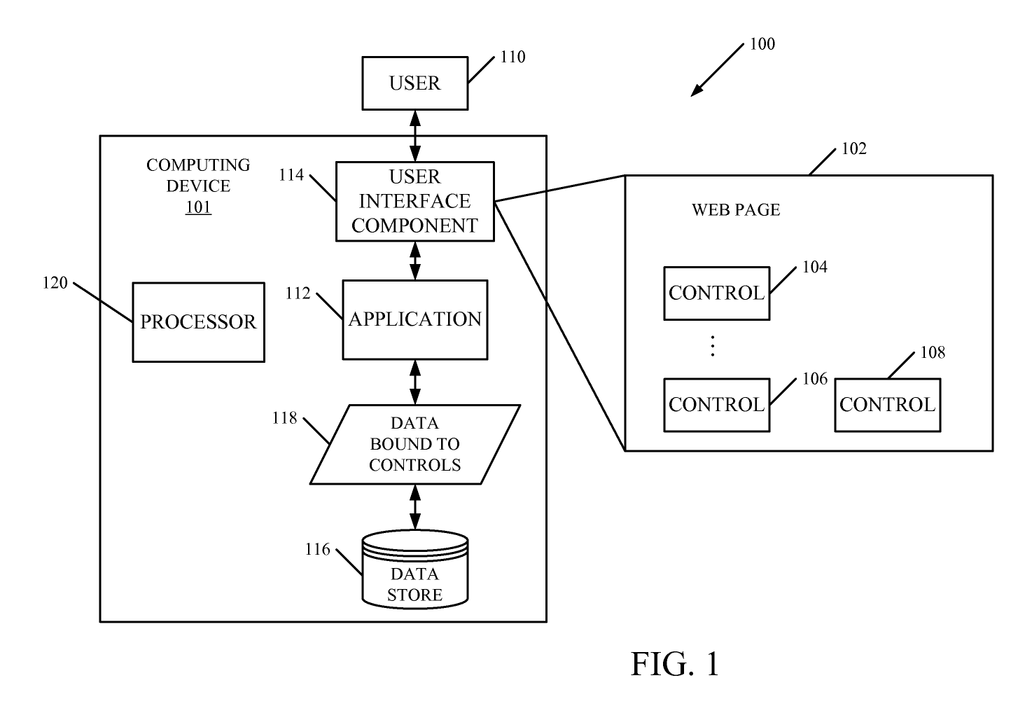

FIG. 1 is a block diagram of a system 100 that includes computing device 101 that generates a user interface display, such as web page 102 with controls 104, 106 and 108 on page 102. System 100 allows a user 110 to interact with application 112 through an appropriate user interface component 114. User interface component 114 illustratively generates user interface displays with user input mechanisms for receiving user inputs. The inputs can take a variety of different forms such as voice, user activation of actuable elements on the display (using touch gestures or point and click devices), a keyboard, etc . . . .

Application 112 operates on data stored in data store 116 in generating web page 102. In one embodiment, the data in data store 116 is represented by a hierarchical data graph of business data in an ERP/CRM system, although other types of data can be used as well.

Computing device 101 also includes processor 120. In one embodiment, processor 120 is a computer processor with associated memory and timing circuitry (not shown). Processor 120 is illustratively a functional element of system 100 and is activated by component 114 and application 112 to facilitate their functionality.

Application 112 illustratively retrieves data from data store 116 that is bound to controls 104-108. The data is indicated by data block 118 in FIG. 1. Thus, when web page 102 is generated and rendered, the data 118 bound to the controls 104-108 is retrieved and applied to controls 104-108. Of course, it should be noted that data 118 can be text or other data, and it can also be behavioral attributes of the controls.

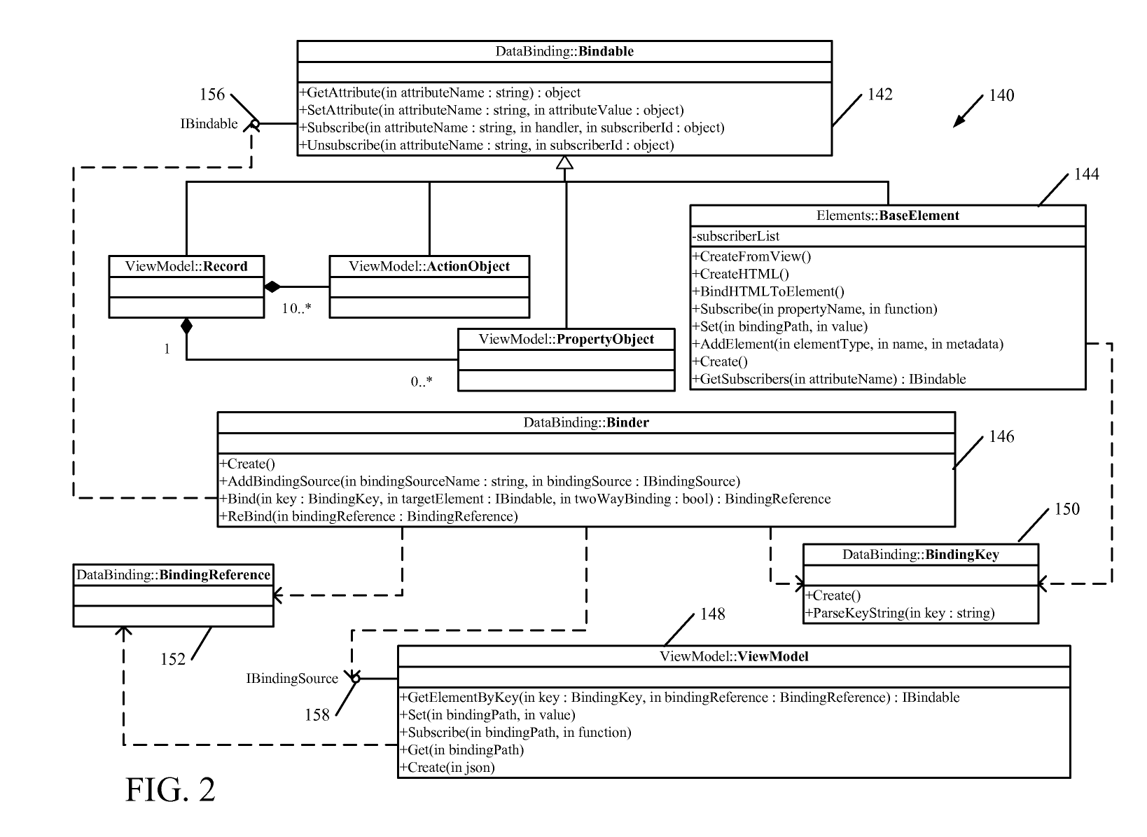

FIG. 2 is a diagram of a binding framework 140 that can be used to bind data to user interface elements, such as controls. Framework 140 includes Bindable class 142, BaseElement class 144, Binder class 146, ViewModel (or BindingSource) class 148, BindingKey 150, and BindingReference 152. Bindable class 142 implements the IBindable interface 156, while ViewModel 148 implements the IBindingSource interface 158. Of course, these classes and interfaces are exemplary only.

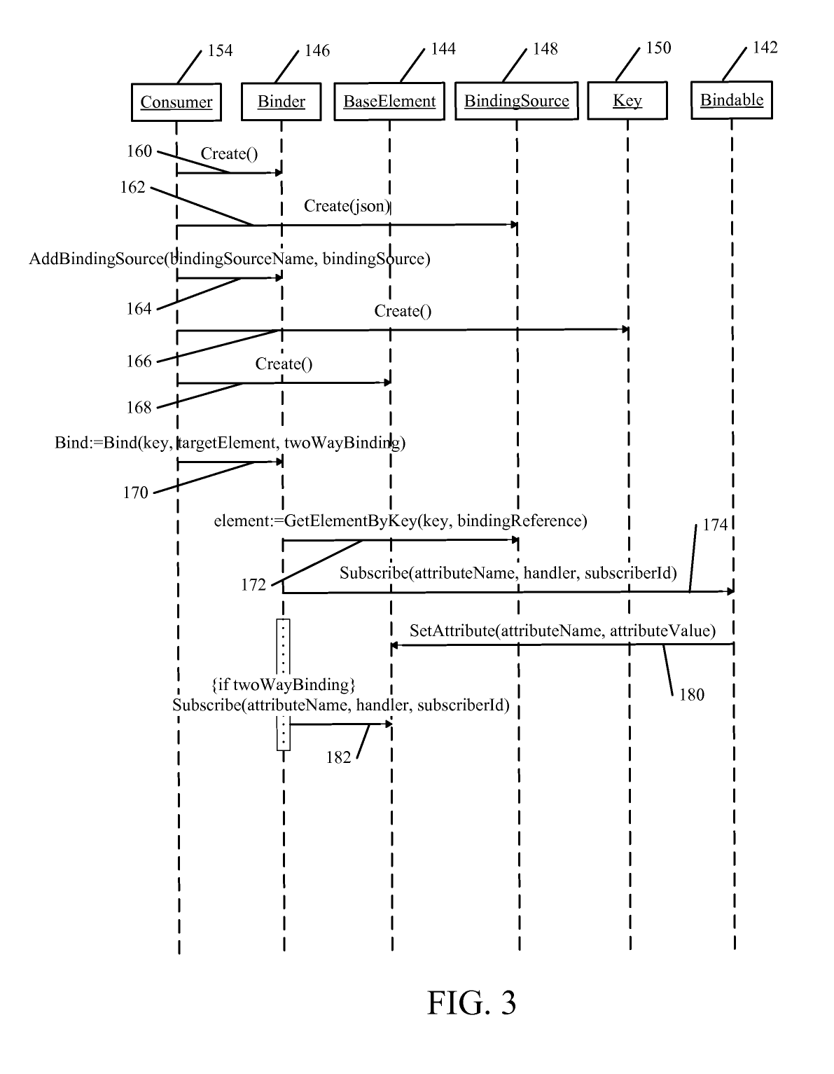

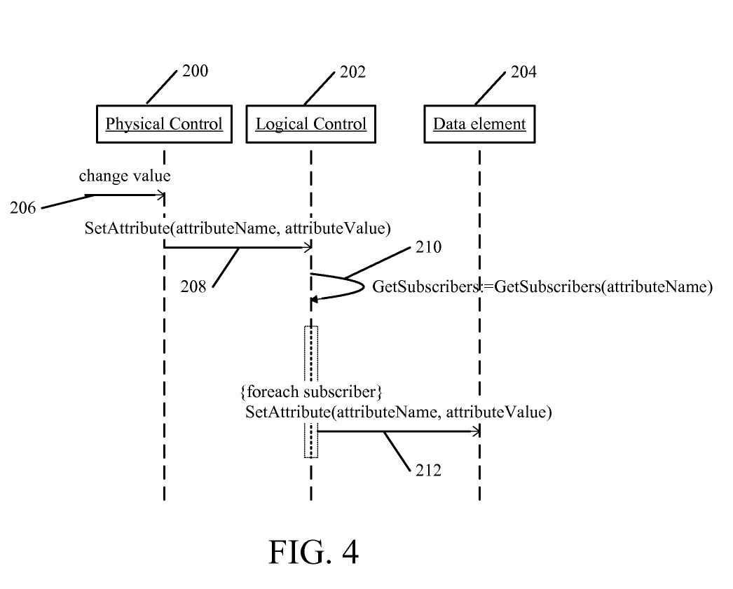

One embodiment of the operation of framework 140 is described with respect to the sequence diagrams of FIGS. 3 and 4. Briefly, however, ViewModel 148 acts as a binding source (or data provider), and implements the IBindingSource interface 158 which allows Binder 146 to call into ViewModel 148 to obtain target elements to bind to. Binder 146 obtains BindingKey 150 which illustratively comprises a path string defining the location of the data element in the hierarchy and retrieves the data element calling the IBindingSource interface 158 on ViewModel class 148.

In one embodiment, the Key 150 comprises a binding path that is a text string. It illustratively starts with a text string that provides the name of the root of a collection and then indicates additional identifiers to identify properties in a collection and even to indicate the name of a specific property. The syntax of a particular binding path can be flexible so that it can represent any object graph that can be instantiated in the system. In one embodiment, the sequence of identifiers is simply indicated as follows:

IdentifierName.IdentifierName.IdentifierName . . .

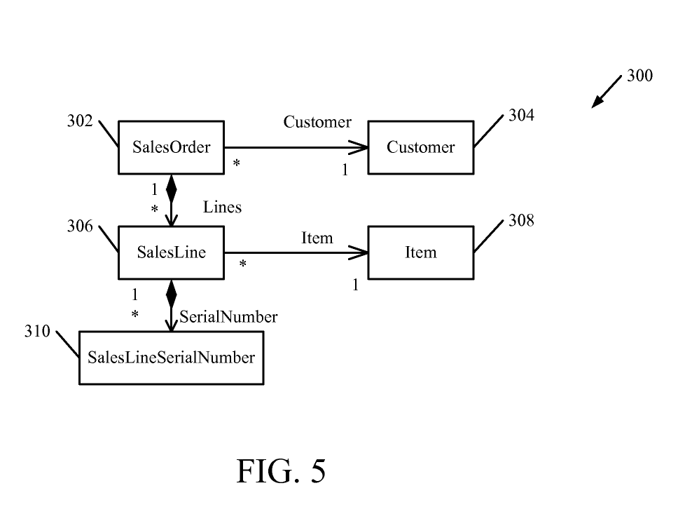

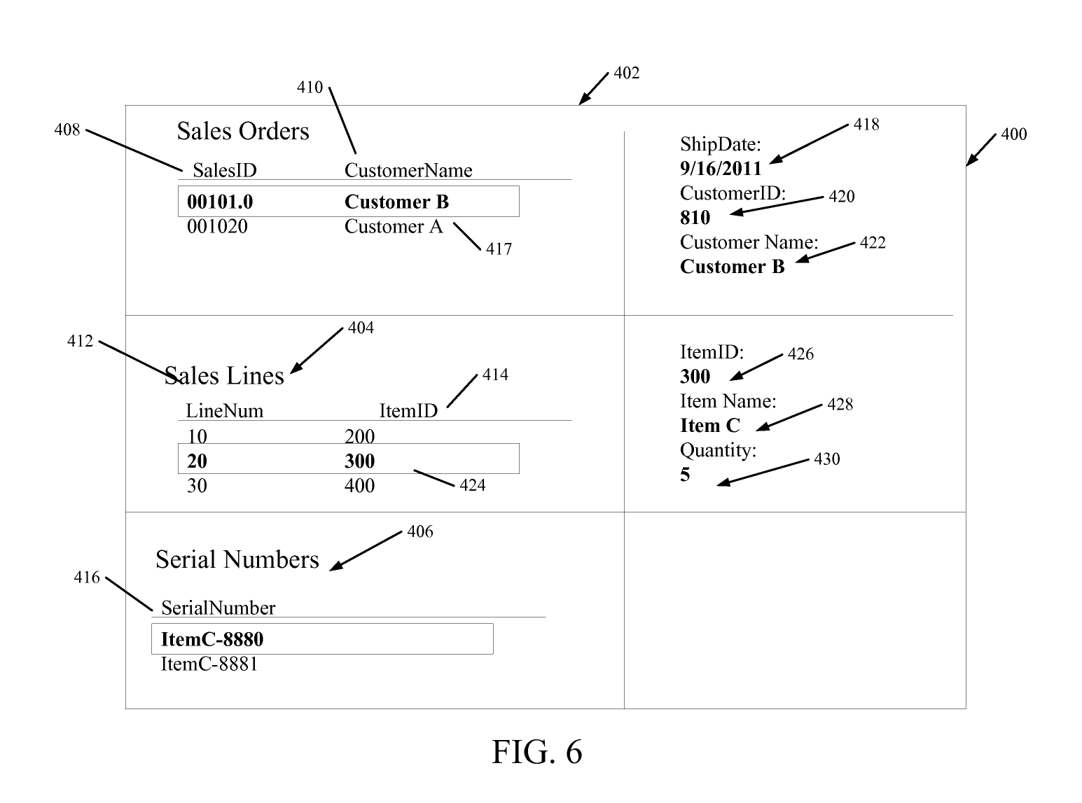

The identifier names are on a particular object that has a property or actions collection that the caller wants to bind to. The sequence is illustratively contained in BindingKey 150. A more specific example is discussed below, with respect to FIGS. 5 and 6.

The data elements returned by ViewModel 148 implement the IBindable interface 156. This interface illustratively defines methods for getting and setting attributes and for subscribing and unsubscribing relative to objects. All of the data elements can derive from a common base class, Bindable 142.

The IBindable interface 156 illustratively allows the data elements to notify any subscribers of data changes. For two-way binding, the target (such as the logical control or base element) also implements the IBindable interface. This allows a value to change on the logical control and flow back to the data. With this in place, Binder 146 can interact with the binding sources and logical controls to bind the logical control and data using subscribe methods.

BindingReference 152 is created with each binding to track and further control the binding. This can be used for the data sources to track the bindings for an active row, for instance. When an active row changes, it can use the BindingReference 152 to refresh the binding. This serves to update the logical controls and the user does not need to rebind any of the user interface elements. Again, a specific example of this is discussed below with respect to FIGS. 5 and 6. Prior to discussing that example, a more general sequence diagram will be discussed.

FIG. 3 shows one embodiment of a sequence diagram for generating a binding between a data element and a logical control. In FIG. 3, the items shown in Framework 140 in FIG. 2 are also shown in FIG. 3, and are similarly numbered. Consumer 154 is illustratively the consumer of the data. For instance, Consumer 154 can be a webpage with controls displayed on it, where the controls are bound to data.

Consumer 154 first creates a Binder instance 146. This is indicated by arrow 160. Next, Consumer 154 creates a BinderingSource instance (such as ViewModel 148). This is indicated by block 162. BindingSource 148 gives Consumer 154 something to bind to. Consumer 154 then adds the newly created BindingSource 148 to the list of things that it can bind to in Binder 146. This is indicated by arrow 164. Consumer 154 then instantiates a BindingKey 150, which describes the hierarchy from which the BindingSource 148 will pull data to bind to controls on Consumer 154. As discussed above, BindingKey 150 can simply be a text string identifying a binding path that can be used by Consumer 154 to bind object properties from a complex object graph to its own controls. It should be noted, of course, that Consumer 154 can do this for multiple different BindingSources 148 and each one can index and retrieve data differently and be used together on one user interface display. Instantiating the BindingKey 150 is indicated by arrow 166 in FIG. 3.

Consumer 154 then creates BaseElement 144 which can be a base class that inherits from Bindable class 142. Once BaseElement 144 is created, it can be bound to BindingSource 148 based on BindingKey 150. Creating a BaseElement 144 is indicated by block 168 in FIG. 3.

Consumer 154 then calls bind on Binder 146. In doing so, Consumer 154 provides the BindingKey 150, the target BaseElement 144 and indicates that it is a two-way binding. This is indicated by block 170 in FIG. 3.

Binder 146 then finds the BindingSource 148 and uses the IBindingSource interface 158 to delegate the look up of the proper element in the hierarchal data structure to ViewModel 148 based upon BindingKey 150. This is indicated by arrow 172 in FIG. 3. Binder 146 then calls subscribe on the IBindable interface 156 of Bindable class 142. In doing so, it provides the specific attribute name, its handler and the subscriber ID for the subscriber. This is indicated by arrow 174 in FIG. 3, and it indicates to Bindable class 142 that the subscriber wishes to know about changes in the particular attribute value specified.

Then, when a user interface (such as a web page) is rendered, Bindable class 142 sets the attribute by providing the attribute name and attribute value in BaseElement 144. This is indicated by block 180 in FIG. 3. That is, the data is propagated from Bindable class 142 to BaseElement 144.

Finally, because two-way binding was specified by arrow 170 when bind was called on Binder 146, Binder 146 also subscribes to the attribute in BaseElement 144, by providing the attribute name, handler and its subscriber ID. This is indicated by arrow 182 in FIG. 3. That way, if the data is changed, Binder 146 can call back to update the value of the attribute.

FIG. 4 is a sequence diagram illustrating how physical and logical controls interact with a data element. In the embodiment shown in FIG. 4, physical control 200 illustratively represents a physical control on a user interface display, such as on a web page. Data element 204 represents a data element that is bound to the physical control 200 and logical control 202. In one embodiment, a change value is input to physical control 200. This is indicated by arrow 206 in FIG. 4. Physical control 200 calls SetAttribute on the logical control by providing the attribute name and attribute value. This is indicated by arrow 208. Logical control 202 obtains the identity of subscribers to the attribute that has changed value. This is indicated by arrow 210. Then, for each subscriber, logical control 202 calls SetAttribute by providing the attribute name and the new attribute value on data element 204, in order to propagate the change indicated by arrow 206. Setting the attributes on each subscriber is indicated by arrow 212 in FIG. 4.

It can thus be seen that the present binding pattern allows a particular element on a user interface display to bind to a particular element in a graph, even if that element is several levels deep within a hierarchal data structure. The present pattern also makes multi-context binding straight-forward. The binding is defined by a binding path where two paths can point to two entirely different spots in a hierarchy, even if they are in completely separate subtrees of the hierarchy. Thus, the binding paths set the context for the binding itself. In addition, because a subscription pattern is followed, it allows the binding framework 140 to easily accomplish change tracking in data elements. When there are data changes, those can be propagated back to the server (or other computing system) that persists the base elements containing the data and it can also take other actions based on those changes. For instance, if the data element is a text element and it has been edited, then that change is tracked, and the change can be shown to another user who has subscribed to receive such changes.

One specific example of how the subscription pattern can be used for change tracking is, for example, in a customer resources management application. A text box may be bound to an order number so that when a user interface is displayed with that text box, it will be populated with a given order number. Elements of the system can subscribe to changes made to that data element. When a change is made, the system automatically calls the SetAttribute method and inspects the data element for subscriptions to it. The system also propagates that data change up to subscribers of changes to the data element.

In addition, the present pattern facilitates implicit binding. For instance, when a view or user interface display element is bound back to a property object that has attributes, those attributes can be behavioral properties that inform the user interface of how to act. With the present pattern, a single binding path allows binding to an object that has a collection of properties. In some prior systems, every property on a control is explicitly bound to a specific property on an object. This is quite labor intensive and cumbersome. By providing a simple binding path to an object that has behavioral properties, the behavioral properties will be implicitly bound to the appropriate user interface elements.

A specific example may assist in understanding. FIG. 5 is one exemplary data model 300, and FIG. 6 shows an exemplary user interface display 400 that is generated using the data model 300 shown in FIG. 5. In the data model 300, SalesOrder 302 is associated with Customer 304 and has a collection of SalesLine entities 306. In addition, SalesLine 306 is associated with Item 308 and has a collection of SalesLineSerialNumbers 310. Data model 300 also shows that SalesOrder 302 will have at least one SalesLine 306, and SalesLine 306 will have at least one SalesLineSerialNumber 310.

FIG. 6 shows that a sales orders user interface display 402 includes sales line display 404 and serial number display 406. The sales orders display 402 includes a SalesID column 408 along with a CustomerName column 410. The sales lines display 404 includes a line number column 412 and an item ID column 414. The serial number display 406 includes a serial number column display 416.

User interface display 400 also shows that, in the embodiment in FIG. 6, the first row 417 in the sales order display 402 is selected, as shown by highlighting. Therefore, user interface display 400 shows the ship date 418 for the selected customer, the customer ID 420 for that customer, and the customer name 422 for that customer.

User interface display 400 also shows that, in the sales line display 404, the second row (or line) 424 is selected. Therefore, user interface display 400 shows the item ID 426, the item name (or item name portion) 428 and the quantity 430 for the selected line (or row) 424 in the sales line display 404.

Table 1 below illustrates example data for the data model 300 and user interface display 400 shown in FIGS. 5 and 6. Table 1 shows some exemplary data for the SalesOrder, the Customer, the SalesLine, the Item, and SalesLineSerialNumber.

TABLE 1
SalesOrder

| SalesID | ShipDate | CustomerID |
|---|---|---|
| 1010 | Sep. 6, 2011 | 810 |
| 1020 | Sep. 7, 2011 | 720 |

Customer

| CustomerID | Name |
|---|---|
| 720 | Customer A |
| 810 | Customer B |

SalesLine

| SalesID | LineID | LineNum | ItemID | Quantity |
|---|---|---|---|---|
| 1010 | 1010-10 | 10 | 200 | 1 |
| 1010 | 1010-20 | 20 | 300 | 2 |
| 1010 | 1010-30 | 30 | 400 | 1 |
| 1020 | 1020-10 | 10 | 100 | 1 |
| 1020 | 1020-20 | 20 | 400 | 2 |

Item

| ItemID | Name |
|---|---|
| 100 | ItemA |
| 200 | ItemB |
| 300 | ItemC |
| 400 | ItemD |

SalesLineSerialNumber

| LineID | SerialNumber |
|---|---|
| 1010-10 | ItemB-9990 |
| 1010-20 | ItemC-8880 |
| 1010-20 | ItemC-8881 |
| 1010-30 | ItemD-7770 |
| 1020-10 | ItemA-9990 |
| 1020-20 | ItemD-7771 |
| 1020-20 | ItemD-7772 |

Each property (such as the SaleID property on the SalesOrder object) is an object with various properties which contain a user interface state that is needed for a control. Some examples of user interface states that might be needed for the control are: value, enabled, read only, and label.

The example user interface display 400 can be constructed with three grid controls and several edit controls. Table 2 below shows one example of how bindings can be specified for those controls.

TABLE 2
SalesOrder Grid

Column1 (SalesID column)

Binding=SalesOrder.SalesId

Column2 (CustomerName column)

Binding=SalesOrder.Customer.Name

SalesOrder Edit Section

Edit1 (Shipdate)

Binding=SalesOrder.ShipDate

Edit2 (CustomerID)

Binding=SalesOrder.CustomerID

Edit3 (CustomerName)

Binding=SalesOrder.Customer.Name

SalesLine Grid

Column1 (LineNumber column)

Binding=SalesOrder.Lines.LineNum

Column2 (ItemID column)

Binding=SalesOrder.Lines.ItemID

SalesLine Edit Section

Edit1 (ItemID)

Binding=SalesOrder.Lines.ItemID

Edit2 (ItemName)

Binding=SalesOrder.Lines.Item.ItemName

Edit3 (Quantity)

Binding=SalesOrder.Lines.Quantity

SerialNumber Grid

Column1 (SerialNumber column)

Binding=SalesOrder.Lines.SerialNumbers.SerialNumber
ReadOnly=SalesOrder.Lines.SerialNumbers.Serial-Number.ReadOnly

Table 2 shows that the grid controls include the SalesOrder grid control, the SalesLine grid control, and the SerialNumber grid control. Edit controls include the SalesOrderEdit section and the SalesLine edit section. Table 2 shows that the binding that can be used to bind the SalesID to the user interface column 408, and the CustomerName to the CustomerName column 410. The SalesOrder edit section shows the binding that can be used to bind the ship date to the first edit control (the ship date portion 418). It also shows the binding that can be used to bind the CustomerID to the CustomerID portion 420 and the Name to the CustomerName portion 422.

The SalesLine grid control shows the bindings that can be used to bind the LineNumber to the LineNumber column 412 and the ItemID to the ItemID column 414. The SalesLine edit control shows bindings that can be used to bind the ItemID, the ItemName and the quantity to the portions 426, 428 and 430 on the user interface display 400, respectively. Finally, the SerialNumber grid control shows the binding that can be used to bind the data to the serial number column display 416.

When the system is interacting with the data graph (represented by the data model 300 shown in FIG. 5 and the data in Table 1) to generate the user interface display 400, the edit controls use their respective bindings as a path along with the active record for each collection to determine the specific entity to show data from. By way of example, and as shown in FIG. 6, the SalesLine grid control shows that the second record (line 424) has been selected and is active. Therefore, the SalesLine edit control shows the data from that same record, because the binding paths have the same base (i.e., the “SalesOrder.Lines” portion of the binding).

An example that shows an implicit binding will now be discussed. Table 3 below shows an example of individual properties, or UI states, that can be bound to an edit control.

TABLE 3

Edit1

Value= SalesOrder.ShipDate.Value
Enabled= SalesOrder.ShipDate.Enabled
ReadOnly= SalesOrder.ShipDate.ReadOnly
Label=SalesOrder.ShipDate.Label

Implicit and explicit property binding can be combined by first applying all implicit bindings and then adding explicit bindings when defined. For each grid control to show the correct value in each cell of user interface display 400, the system (e.g., the control run time implemented by processor 120) illustratively adjusts the binding path to use integer indexing for each collection, in order to allow each grid row to show a different entity. The collection lowest down in the data graph (represented by data model 300 and the example data shown in Table 1) illustratively has the indexer, meaning that collections higher in the data graph use the active record (the record selected by the user in user interface display 400 of FIG. 6). Table 4 shows one example of the implicit bindings for each grid cell in user interface display 400. It should be noted, however, that explicit bindings can also be used on a row, column, or cell basis.

TABLE 4
Sales Order Grid Column Binding:

| SalesID | CustomerName |
|---|---|
| SalesOrder[0].SalesID | SalesOrder[0].Customer.CustomerName |
| SalesOrder[1].SalesID | SalesOrder[1].Customer.CustomerName |

SalesLine Grid Column Binding:

| LineNum | ItemID |
|---|---|
| SalesOrder.Lines[0].LineNum | SalesOrder.Lines[0].ItemID |
| SalesOrder.Lines[1].LineNum | SalesOrder.Lines[1].ItemID |

SerialNumber Grid Column Binding:
SerialNumber

SalesOrder.Lines.SerialNumbers[0].SerialNumber
SalesOrder.Lines.SerialNumbers[1].SerialNumber

When the user changes the active record in a grid (such as by selecting a different line in one of the grid controls), all of the controls binding lower in the data graph are updated accordingly.

An example of multiple context binding will now be discussed. In order to illustrate multiple context binding, assume that a metadata store is added for each of the entities (e.g., for the SalesOrder entity, the Customer entity, the SalesLine entity, etc. shown in the data model of FIG. 5). Assume also that each of the entities has common metadata, such as “Label” metadata, “HelpText” metadata, etc. Table 5 below shows one example of a metadata store for the SalesOrder entity.

TABLE 5
SalesOrderMetadata

| SalesID | Label | Help Text |
|---|---|---|
| ShipDate | Date the Order shipped | This is the date that the |
| | | order was shipped form the |
| | | packing facility |
| SalesID | Sales Order Id | The sales order unique |
| | | identifier |

Table 6 below shows illustrative bindings for the SalesOrder grid controls for the SalesID column 408 and CustomerName column 410 in the user interface display 400 shown in FIG. 6. It can be seen that multiple-context bindings can be created by binding to different sources. For instance, Table 6 shows that the SalesID column binds not only to the SalesOrder table to show the SaleID, but also to the SalesOrderMetadata table to show the label for that SalesID. By simply specifying two different bindings, grid control can be bound to two different contexts.

TABLE 6
SalesOrder Grid Column Binding:

| SalesID | CustomerName |
|---|---|
| SalesOrder[0].SalesID | SalesOrder[0].Customer.CustomerName |
| SalesOrderMetadata.SalesID.Label | |
| SalesOrder[1].SalesID | SalesOrder[1].Customer.CustomerName |
| SalesOrderMetadata.SalesID.Label | |

It should also be noted that the components of the system discussed above can be arranged in different ways. For instance, they can be combined to form fewer applications and components, or they can be further divided into more components or applications. In addition, they could be used in other architectures as well. They can be server-based, divided among various devices that are remote from one another, or deployed in a could-computing architecture.

A cloud computing architecture illustratively include infrastructure, platforms and applications. The cloud services are coupled to other devices or systems such as cloud servers, desktop computers, tablet computers, laptop computers, cellular phones or smart phones or other mobile devices or personal digital assistants. Cloud computing provides computation, software, data access, and storage services, rather than products, that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location in the cloud. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on a client device directly, or in other ways.

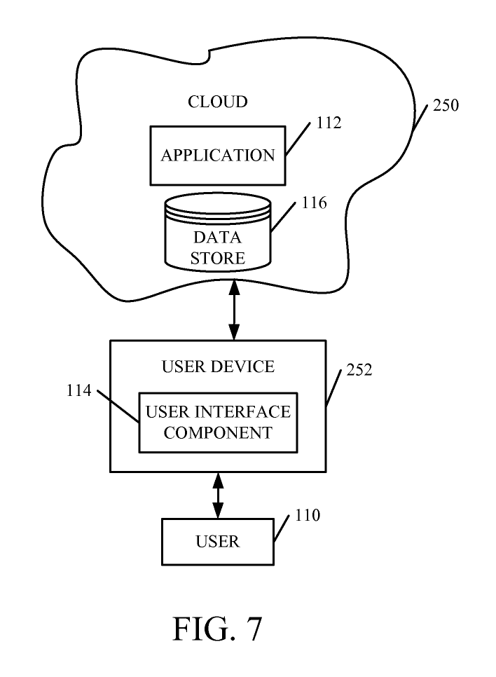

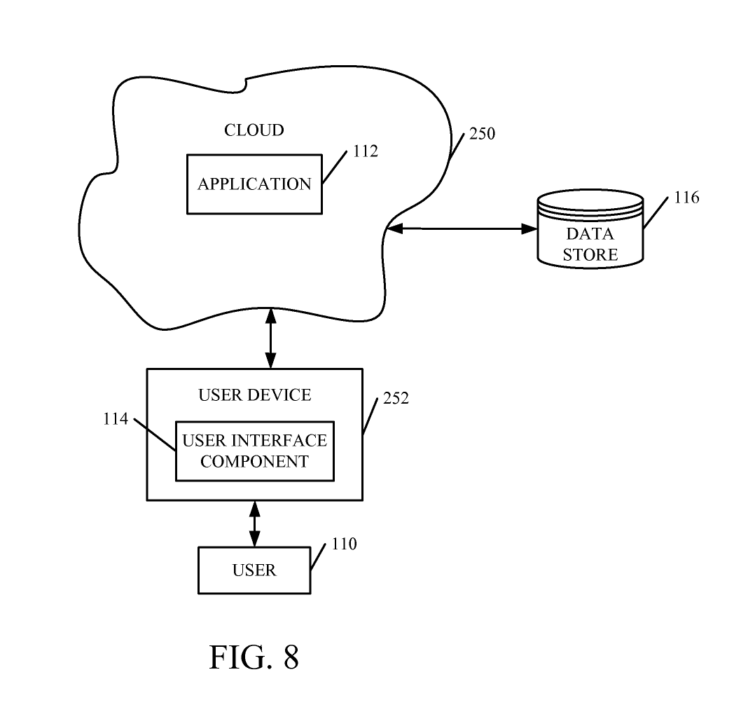

FIG. 7 shows one embodiment of application 112 in a cloud computing environment. FIG. 7 shows that both application 112 and data store 116 are stored in cloud 250. User 110 is shown interacting with a user device 252 that includes user interface component 114. It should be noted that the items (components and applications) discussed above can distributed in other ways as well. For example, FIG. 8 shows that only application 112 is provided as a cloud service in cloud 250. Data store 116, however, is located external to cloud 250 and could be a server-based data store or another data store located remotely or locally. Again, user device 252 is shown with user interface component 114 disposed thereon.

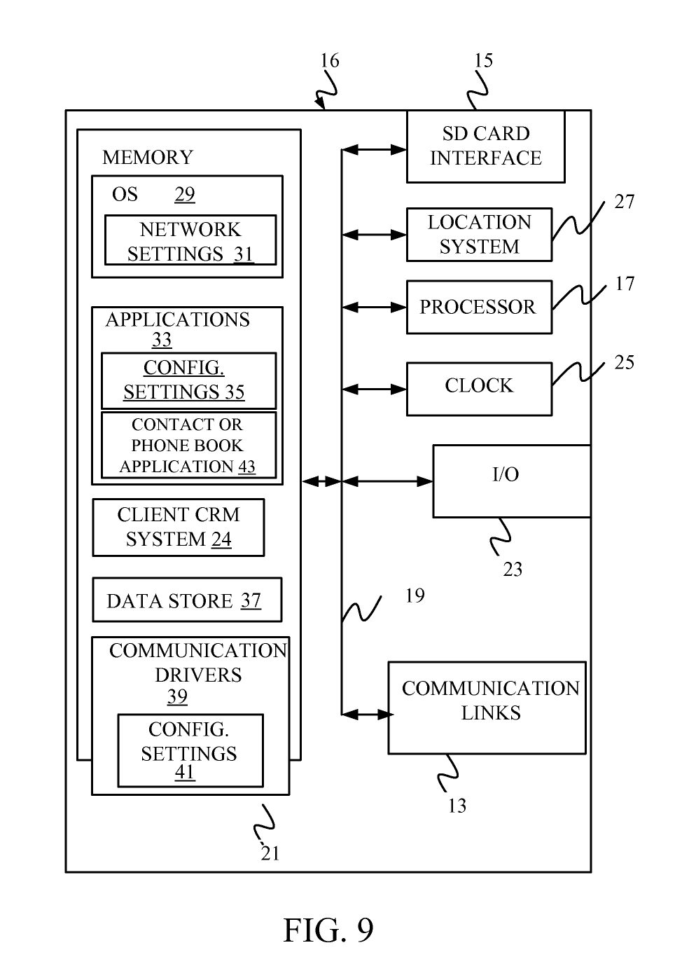

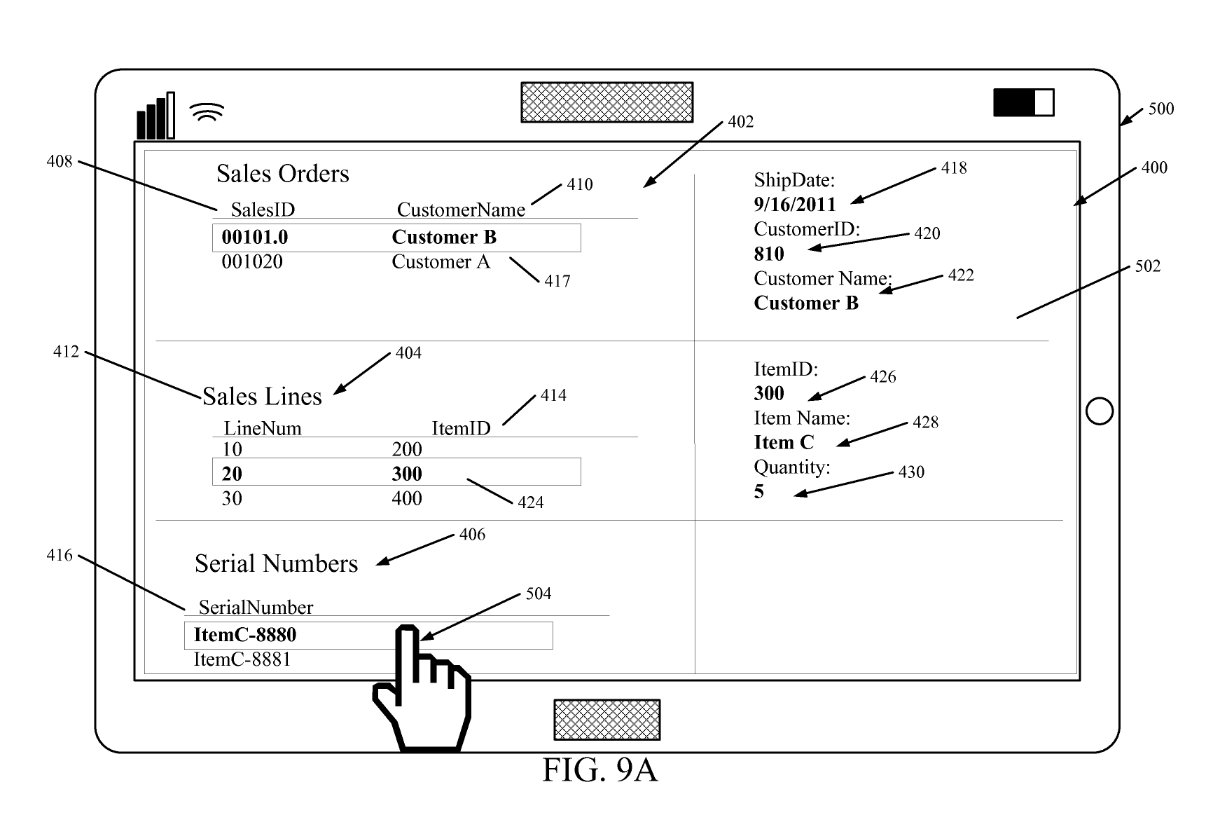

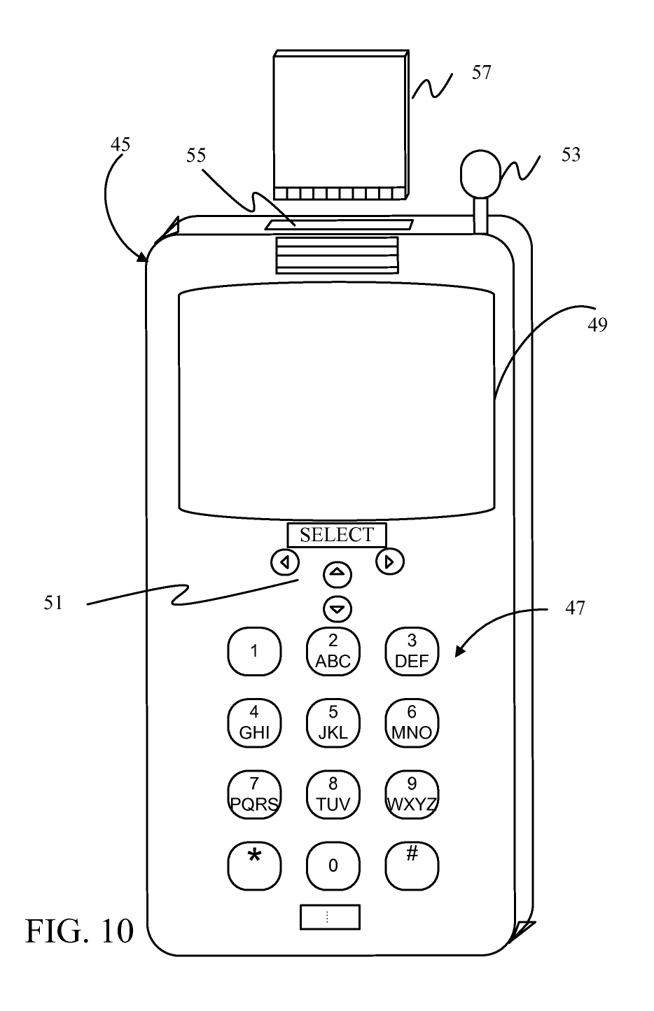

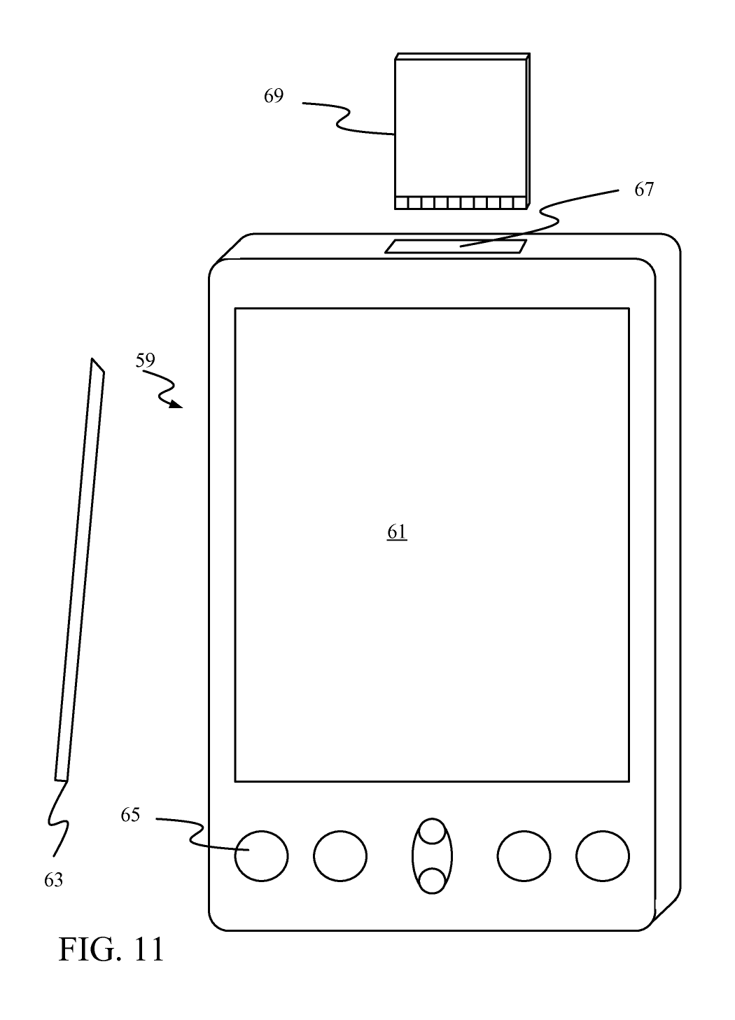

System 100 (or components of system 100) can also run on a variety of computing devices, such as desktop computers, laptops, tablet computers, smart phones, cell phones, multimedia players, personal digital assistants, etc. FIG. 9 is a simplified block diagram of one illustrative embodiment of a handheld or mobile computing device that can be used as user device (or client device) 101, 252, in which the present system (or parts of it) can be deployed, or which can be used to access the present system. FIGS. 10 and 11 are examples of handheld or mobile devices.

FIG. 9 provides a general block diagram of the components of a client device 16 that can be user device 101 or 252 and can run components of system 100 or that interacts with system 100. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Portions of system 100, for example, can reside in memory 21. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 9A shows an embodiment in which system 100 can be implemented on a tablet or slate computer 500. Computer 500 is shown with user interface display 400 displayed on the display screen 502. Screen 502 can be a touch screen (so touch gestures from a user's finger 504 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 500 can also illustratively receive voice inputs as well.

FIGS. 10 and 11 provide examples of devices 16 that can be used, although others can be used as well. In FIG. 10, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 11 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible. Examples include tablet computing devices, music or video players, and other handheld computing devices.

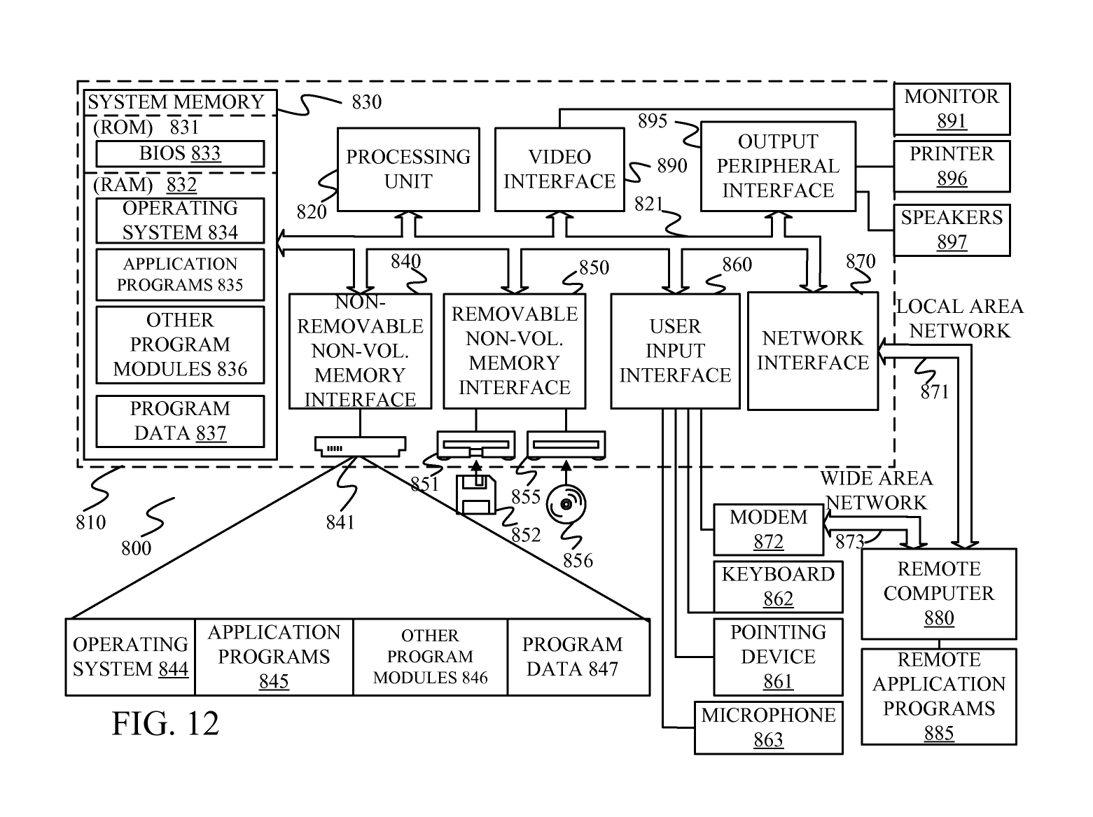

FIG. 12 is one embodiment of a computing environment 800 in which system 100 (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 120), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of generating a display of data arranged in a hierarchical data structure, comprising:
receiving a request to display a hierarchical list in a user interface control;
in response to the request:
receiving a first data element from a first location in the hierarchical data structure and associated with a first element in the hierarchical list;
receiving a second data element from a second location in the hierarchical structure, associated with a second element in the hierarchical list; and
displaying the user interface control with the first data element at a first level in the hierarchical list and the second data element at a second level in the hierarchical list.

2. The computer-implemented method of claim 1 wherein receiving the first data element comprises:
accessing a first binding path associated with the first element in the hierarchical list, the first binding path identifying the first location, having a first context, in the hierarchical data structure; and
obtaining the first data element from the first location.

3. The computer-implemented method of claim 2 wherein receiving the second data element comprises:
accessing a second binding path associated with the second element in the hierarchical list, the second binding path identifying the second location, having a second context, in the hierarchical data structure; and
obtaining the second data element from the second location.

4. The computer-implemented method of claim 3 wherein the hierarchical data structure has a plurality of different levels and wherein the first and second locations are on first and second levels, respectively, of the hierarchical data structure.

5. The computer-implemented method of claim 4 wherein displaying the user interface control comprises:
displaying a third data element from a third level in the hierarchical data structure;
receiving a user input selecting one of the first, second and third data elements as an active data element; and
automatically updating display of data elements on the user interface display that are from a level in the hierarchical data structure below a level of the active data element.

6. The computer-implemented method of claim 4 wherein receiving the first data element comprises:
identifying a first data provider from the first binding path that retrieves the first data element; and
obtaining the first data element from the first data provider.

7. The computer-implemented method of claim 6 wherein receiving the second data element comprises:
identifying a second data provider, different from the first data provider, from the second binding path that retrieves the second data element; and
obtaining the second data element from the second data provider.

8. The computer-implemented method of claim 7 wherein the first and second binding paths use first and second syntaxes, respectively, the first syntax corresponding to the first data provider and the second syntax corresponding to the second data provider, wherein accessing the first binding path comprises:
accessing the first binding path that specifies the first location using the first syntax.

9. The computer-implemented method of claim 8 wherein accessing the second binding path comprises:
accessing the second binding path that specifies the second location using the second syntax.

10. The computer-implemented method of claim 3 wherein the first binding path specifies a two-way binding and further comprising:
receiving a user input on the user interface control changing the first data element; and
storing the changed first data element at the first location in the hierarchical data structure.

11. The computer-implemented method of claim 3 wherein the second binding path specifies a two-way binding and further comprising:
receiving a user input on the user interface control changing the second data element; and
storing the changed second data element at the second location in the hierarchical data structure.

12. The computer-implemented method of claim 3 and further comprising:
binding the first and second data elements to the first and second elements, respectively, of the user interface control.

13. The computer-implemented method of claim 3 wherein binding the first data element to the first element of the user interface control, comprises:
creating an instance of a binding source entity, a binder entity and a base element entity, the base element entity identifying a target element entity representing the user interface control;
indicating to the binder entity that the binding source entity is a source of bindable data elements, including the first data element, with values that can be bound to the user interface control represented by the base element entity;
generating a key, representative of the first binding path, that specifies a particular location in the hierarchical data structure that holds the first data element to be bound to the user interface control;
binding the first data element specified by the key to the first element in the target element entity by providing the key to the binder entity to indicate that the first data element specified by the key is bound to the target element entity in the base element; and
locating, with the binder entity, the first data element specified by the key and subscribing to the first data element.

14. The computer-implemented method of claim 13 wherein displaying the user interface control comprises:
rendering the user interface control by propagating the value from the first data element to the logical control represented by the base element entity.

15. A business data processing system, comprising:
a business application generating a user interface display with a control that shows data from a store of business data stored as data records according to a hierarchical data model having a plurality of different levels, a first record on a first level of the plurality of levels referring to a second record on a second level, the second record referring to a third record on a third level, the application displaying the control on the user interface display with data from at least the first and second records by accessing binding paths for each of the first and second records displayed in the control and updating the data displayed based on which record is selected as an active record; and
a computer processor, being a functional component of the system and activated by the application to facilitate generating the user interface display and accessing the binding paths.

16. The business data processing system of claim 15 wherein data for the records displayed in the control are provided from separate locations in the hierarchical data model and wherein the binding paths comprise a separate binding path specifying each of the separate locations.

17. The business data processing system of claim 16 wherein the second level is located lower in the hierarchical data model than the first level, and wherein, when a different record on the first level is selected as the active record, the business application automatically obtains a new binding path for the second record, as indicated by the active record, and updates data displayed in the second record based on the new binding path.

18. The business data processing system of claim 15 wherein the business application tracks changes made to control values for the control and stores the changes in the store.

19. The business data processing system of claim 15 wherein the business application tracks changes made to the data displayed for the control and stores the changes in the store.

20. A computer readable medium that stores computer executable instructions which, when executed by a computer, cause the computer to perform a method, comprising:
receiving a request to display a hierarchical list in a user interface control;
in response to the request:
receiving a first data element from a first location in the hierarchical data structure and associated with a first element in the hierarchical list, by accessing a first binding path associated with the first element in the hierarchical list, the first binding path identifying the first location, having a first context, in the hierarchical data structure;
obtaining the first data element from the first location;
receiving a second data element from a second location in the hierarchical structure, associated with a second element in the hierarchical list by accessing a second binding path associated with the second element in the hierarchical list, the second binding path identifying the second location, having a second context, in the hierarchical data structure, and obtaining the first data element from the second location; and
displaying the user interface control with the first data element at a first level in the hierarchical list and the second data element at a second level in the hierarchical list.
